(19) United States
(12) Patent Application Publication
(10) Pub. No.: US 2006/0288180 A1
(43) Pub. Date: Dec. 21, 2006

(54) Programmable memory write protection method and system

(75) Inventors: Wh Shih, Taipei (TW); Chin-Fong Pan, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/153,511

(22) Filed: Jun. 15, 2005

(51) Int. Cl. G06F 12/14

(52) U.S. Cl. 711/163

(57) ABSTRACT

A programmable memory write protection method and system is proposed, which is designed for use with a computer platform equipped with a programmable memory unit such as a flash memory unit for providing the flash memory unit with a write protection function, and which is characterized by the utilization of identification code to check whether a client unit is authorized to gain access to a flash memory unit; if YES, the write request from the client unit is allowed, and whereas if NO, the write request from the client unit is disallowed. This feature can help protect the BIOS program stored in flash memory against hackers and virus programs without having to utilize the dual BIOS method that would require large layout space on circuit board to implement and also allows authorized upgrade to the BIOS program to be more convenient and efficient to implement than prior art.

### BACKGROUND OF THE INVENTION

1. Field of the Invention

This invention relates to information technology (IT), and more particularly, to a programmable memory write protection method and system which is designed for use in conjunction with a computer platform equipped with a programmable memory unit, such as a flash memory unit, for the purpose of providing the flash memory unit with a write protection function that can help protect the data stored in the programmable memory unit against unauthorized access and tampering.

2. Description of Related Art

BIOS (Basic Input/Output System) is a firmware program utilized by a computer platform, such as desktop computer, notebook computer, network server, and the like, for serving as an interface between the operating system and the various hardware components (including peripheral devices) on the computer platform, for the purpose of allowing the computer platform to control the operations of these hardware components and peripheral devices through the operating system. In practical implementation, the BIOS program is realized by computer code that is developed by software engineers and stored in a programmable memory unit in the computer platform, such as a flash memory unit.

In network applications, servers are typically provided with a remote access capability that allows system management personnel to remotely use a client workstation to gain access to a server and modify the BIOS program therein via network connections. One problem to this remote access capability, however, is that it could also undesirably allow unauthorized users, such as hackers, to remotely gain access to the servers and illegally change the contents of the BIOS program to crash the server operations.

Presently, in order to prevent the above-mentioned problem of server crash due to tamping in BIOS, there are two available solutions: dual BIOS method and hardware jumper method.

The dual BIOS method is implemented by utilizing two separate flash memory units for the storage of the same BIOS program in two copies, or alternatively by utilizing a single flash memory unit and partitioned its storage space into two parts for storing two copies of the same BIOS program. One drawback to this solution, however, is that it is considerably costly to implement and would occupy more layout space on the circuit board.

The hardware jumper method is implemented by utilizing GPIO (General Purpose Input/Output) pins to set the BIOS-installed flash memory unit to either write mode or operating mode. When the user wants to write data to the flash memory unit, the user needs first to switch off the power of the computer platform, then remove the casing and flip the inside jumpers to set to write mode, and then switch on the power of the computer platform and execute a write procedure on the flash memory unit to upgrade the BIOS program therein. When the write procedure is completed, the user needs to switch off the power of the computer platform, flip the jumpers to set to operating mode, remount the casing, and switch on the power of the computer platform. When this tedious task is completed, the computer platform can then operate with the newly upgraded BIOS program. One advantage to the hardware jumper method is that it can help protect the BIOS program in the flash memory unit against hackers since hackers are unable to gain access to the hardware jumpers. However, one apparent drawback to this solution is that it is highly tedious to implement, then undesirably making authorized upgrade to BIOS program very laborious and time-consuming and thus inefficient.

### SUMMARY OF THE INVENTION

It is therefore an objective of this invention to provide a programmable memory write protection method and system which can protect the BIOS program in flash memory against unauthorized access by hackers or virus programs without having to utilize the dual BIOS method that requires large layout space on circuit board to implement.

It is another objective of this invention to provide a programmable memory write protection method and system which can protect the BIOS program in flash memory against unauthorized access by hackers or virus programs, but can nevertheless allow authorized upgrade to the BIOS program to be very convenient and efficient to implement.

The programmable memory write protection method and system according to the invention is designed for use in conjunction with a computer platform equipped with a programmable memory unit, such as a flash memory unit, for the purpose of providing the flash memory unit with a write protection function that can help protect the data stored in the programmable memory unit against unauthorized access and tampering.

In terms of method, the invention comprises: (1) prestoring a group of authorized identification code sets in the computer platform; (2) in actual operation when a client unit issues a write request to the programmable memory unit, (3) responding to the write request by issuing an identification code requesting enable message; (4) responding to the identification code requesting enable message by requesting the client unit to furnish a set of identification code; and if the client unit fails to furnish, issuing a write inhibit message; (5) comparing the identification code furnished by the client unit against the prestored identification code to see if there is a match; if YES, issuing a write enable message; and whereas if NO, issuing a write inhibit message; (6) responding to the write enable message by allowing the client unit to perform a write operation on the programmable memory unit; and (7) responding to the write inhibit message by inhibiting the client unit from gaining access to the programmable memory unit.

In terms of system, the invention comprises the following essential constituent elements: (a) an identification code storage module, which is used to prestore a group of authorized identification code sets; (b) a write request responding module, which is capable of responding to a write request from a client unit by issuing an identification code requesting enable message; (c) an identification code requesting module, which is capable of responding to the identification code requesting enable message from the write request responding module by requesting the client unit to furnish a set of identification code; and if the client unit fails to furnish, capable of issuing a write inhibit message; (d) an identification code comparison module, which is capable of comparing the identification code furnished by the client unit against the identification code stored in the identification code storage module to see if there is a match; if YES, capable of issuing a write enable message; and whereas if NO, capable of issuing a write inhibit message; and (e) a write operation control module, which is capable of responding to the write enable message from the write operation control module to allow the client unit to perform a write operation on the programmable memory unit, and otherwise capable of responding to the write inhibit message from the write operation control module or the identification code requesting module to inhibit the client unit from gaining access to the programmable memory unit.

The programmable memory write protection method and system according to the invention is characterized by the utilization of identification code to check whether a client unit is authorized to gain access to a flash memory unit; if YES; the client unit is allowed to gain access to the flash memory unit, and whereas if NO, the client unit is disallowed to gain access to the flash memory unit. This feature can help protect the BIOS program stored in flash memory against hackers and virus programs without having to utilize the dual BIOS method that would require large layout space on circuit board to implement and also allows authorized upgrade to the BIOS program to be more convenient and efficient to implement than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and modularized object-oriented component model of the programmable memory write protection system of the invention; and

FIG. 2 is a schematic diagram showing an example of an identification code input dialog box utilized by the programmable memory write protection system of the invention.

### DETAILED DESCRIPTION OF PREFERRED EMBODIMENTS

The programmable memory write protection method and system according to the invention is disclosed in full details by way of preferred embodiments in the following with reference to the accompanying drawings.

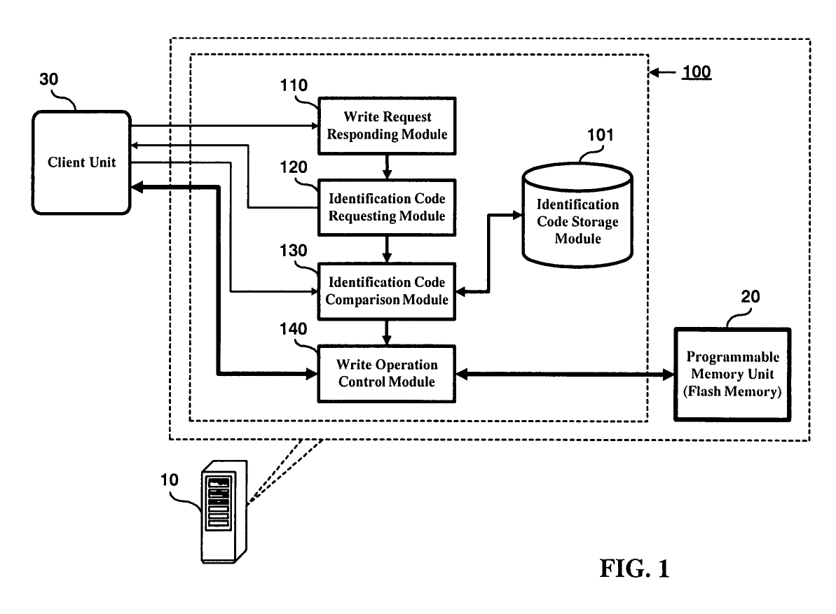

FIG. 1 is a schematic diagram showing the application architecture and modularized object-oriented component model of the programmable memory write protection system according to the invention (as the part enclosed in the dotted box indicated by the reference numeral 100). As shown, the programmable memory write protection system of the invention 100 is designed for use in conjunction with a computer platform 10, such as a desktop computer or a network server, that is equipped with a programmable memory unit, such as a flash memory unit 20, for the purpose of providing the flash memory unit 20 with a write protection function that can help protect the data stored in the flash memory unit 20 against unauthorized access and tampering from a client unit 30, such as a hacker's remote network workstation or a virus program that has intruded into the computer platform 10.

As shown in FIG. 1, the modularized object-oriented component model of the programmable memory write protection system of the invention 100 comprises: (a) an identification code storage module 101; (b) a write request responding module 110; (c) an identification code requesting module 120; (d) an identification code comparison module 130; and (e) a write operation control module 140. In practical implementation, for example, the programmable memory write protection system of the invention 100 can be entirely realized as computer code and integrate the computer code as an add-on software or firmware module to the BIOS (Basic Input/Output System) of the computer platform 10 to allow the BIOS to offer the intended write protection function, and wherein the computer code of the identification code requesting module 120 and the associated identification code input dialog box 121 are integrated to the flash utility of the flash memory unit 20.

The identification code storage module 101 is used to prestore one or more preassigned identification code sets associated with the computer platform 10, including, for example, a unique platform identification name PLATFORM_ID and a group of authorized passwords [PASSWORD(1), PASSWORD(2), . . . , and PASSWORD(N)] which are preassigned to a group of authorized users, i.e., system management personnel who are authorized to modify or update the data stored in the flash memory unit 20. In practical implementation, for example, the identification code storage module 101 can be realized by partitioning the storage space of the flash memory unit 20 with an identification code storage area and then store all the identification code data, i.e., PLATFORM_ID and [PASSWORD(1), PASSWORD(2) . . . , PASSWORD(N)], in this partitioned storage area in the flash memory unit 20.

The write request responding module 110 is capable of responding to a write request from a client unit 30 by issuing an identification code requesting enable message to the identification code requesting module 120. The client unit 30 can be either the operating system of the computer platform 10, an application running on the computer platform 10, a remote network workstation (which may be operated by an authorized user or a hacker), or a virus program that has intruded into the computer platform 10.

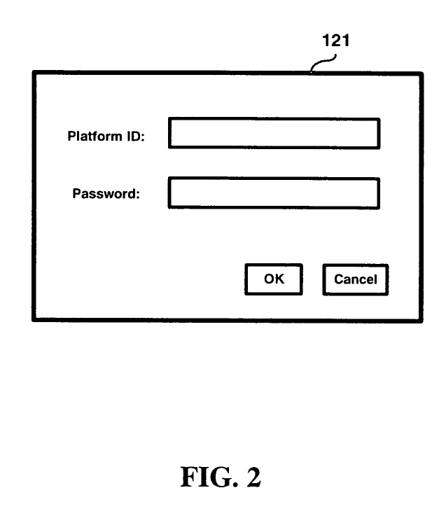

The identification code requesting module 120 is capable of responding to the identification code requesting enable message from the write request responding module 120 by requesting the client unit 30 to furnish an authorized set of identification code, i.e., the platform ID and an authorized password preassigned to the user of the client unit 30. In the case that the client unit 30 is an application program running on the computer platform 10 or a remote network workstation (not shown), the identification code requesting module 120 will display an identification code input dialog box 121 as illustrated in FIG. 2 for the user to input the identification code. If the client unit 30 fails to furnish platform ID and password (i.e., the user clicks the CANCEL button in the identification code input dialog box 121 and thus no input is received therefrom), the identification code requesting module 120 will promptly issue a write inhibit message to the write operation control module 140; and whereas if a user-inputted set of identification code (platform ID and password) is received, the identification code requesting module 120 will issue a comparison enable message to the identification code comparison module 130. On the other hand, in the case that the client unit 30 is an application program which is authorized to gain access to the flash memory unit 20, then the required identification code can be pre-embedded in the application program, so that when the identification code requesting module 120 makes a request, the application program can furnish the embedded identification code to the identification code requesting module 120 via software interactions.

The identification code comparison module 130 is capable of responding to the comparison enable message from the identification code requesting module 120 by comparing the identification code furnished by the client unit 30 against the authorized identification code stored in the identification code storage module 101 to check whether the furnished identification code is authorized, i.e., whether the furnished platform ID is matched to the PLATFORM_ID and if the furnished password is matched to any one of [PASSWORD(1), PASSWORD(2), . . . , PASSWORD(N)]. If YES (a match is found), the identification code comparison module 130 will issue a write enable message to the write operation control module 140; and whereas if NO (no match is found), the identification code comparison module 130 will issue a write inhibit message to the write operation control module 140.

The write operation control module 140 is capable of being activated in response to the write enable message from the write operation control module 140 to allow the client unit 30 to perform a write operation on the programmable memory unit 20, and otherwise capable of responding to the write inhibit message from either the write operation control module 140 or the identification code requesting module 120 to inhibit the client unit 30 from gaining access to the programmable memory unit 20.

In the following first example of a practical application of the invention, it is assumed that the client unit 30 is operated by an authorized user. In this case, when the user wants to change the BIOS program in the flash memory unit 20 (for example, to upgrade the BIOS program), the user needs first to utilize the client unit 30 to issue a write request to the flash memory unit 20. This action will promptly activate the programmable memory write protection system of the invention 100 to operate, wherein the write request responding module 110 responds to the write request by issuing an identification code requesting enable message to the identification code requesting module 120, causing the identification code requesting module 120 to request the client unit 30 to furnish authorized identification code. If the client unit 30 is operated by a user, the identification code requesting module 120 will display an identification code input dialog box 121 as illustrated in FIG. 2 for the user to input the requested identification code (i.e., platform ID and password). If the client unit 30 is a self-executable program that is pre-embedded with the identification code, then the client unit 30 can automatically respond by furnishing the embedded identification code (platform ID and password) to the identification code requesting module 120 via software interactions. In this case, if the client unit 30 is a virus program or a hacker's network workstation, then since it will be unable to furnish authorized identification code, the identification code requesting module 120 will issue a write inhibit message to the write operation control module 140 so as to inhibit the client unit 30 from gaining access to the flash memory unit 20.

If the client unit 30 has furnished a set of identification code (whether a user-inputted set of identification code or an embedded set of identification code), it will cause the identification code requesting module 120 to respond by issuing a comparison enable message to the identification code comparison module 130, thereby activating the identification code comparison module 130 to compare the received identification code against the identification code stored in the identification code storage module 101 to check whether the received platform ID is matched to the PLATFORM_ID and whether the received password is matched to any one of [PASSWORD(1), PASSWORD(2), . . . , PASSWORD(N)]. If YES, the identification code comparison module 130 will issue a write enable message to the write operation control module 140 to cause the write operation control module 140 to be enabled to allow the client unit 30 to perform a write operation on the programmable memory unit 20.

On the other hand, if the client unit 30 is operated by an unauthorized user, such as a hacker, who has no authorized identification code for inputting to the identification code input dialog box 121, then in this case if the hacker ignores the identification code input dialog box 121 (i.e., by pressing the CANCEL button shown in FIG. 2), it will cause the identification code requesting module 120 to promptly issue a write inhibit message; and if the hacker has inputted a wrong platform ID and a wrong password into the identification code input dialog box 121, it will subsequently cause the identification code comparison module 130 to find no match and thus issue a write inhibit message. The issuing of the write inhibit message will cause the write operation control module 140 to be inhibited such that the client unit 30 is disallowed to gain access to the programmable memory unit 20.

Besides, in the case that the client unit 30 is a virus program, then since the virus program has no embedded identification code to furnish, it will fail to respond to the request from the identification code requesting module 120, thus causing the identification code requesting module 120 to issue a write inhibit message to the write operation control module 140 such that the virus program will be unable to gain access to the flash memory unit 20.

In conclusion, the invention provides a programmable memory write protection method and system for use with a computer platform equipped with a programmable memory unit for providing the programmable memory unit with a write protection function, and which is characterized by the utilization of identification code to check whether a client unit is authorized to gain access to a flash memory unit; if YES, the client unit is allowed to gain access to the flash memory unit, and whereas if NO, the client unit is disallowed to gain access to the flash memory unit. This feature can help protect the BIOS program stored in flash memory against hackers and virus programs without having to utilize the dual BIOS method that would require large layout space on circuit board to implement and also allows authorized upgrade to the BIOS program to be more convenient and efficient to implement than prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A programmable memory write protection method for use on a computer platform equipped with a programmable memory unit for providing the programmable memory unit with a write protection function;
the programmable memory write protection method comprising:
prestoring a group of authorized identification code sets in the computer platform;
in actual operation when a client unit issues a write request to the programmable memory unit,
responding to the write request by issuing an identification code requesting enable message;
responding to the identification code requesting enable message by requesting the client unit to furnish a set of identification code; and if the client unit fails to furnish, issuing a write inhibit message;
comparing the identification code furnished by the client unit against the prestored identification code to see if there is a match; if YES, issuing a write enable message; and whereas if NO, issuing a write inhibit message;
responding to the write enable message by allowing the client unit to perform a write operation on the programmable memory unit; and
responding to the write inhibit message by inhibiting the client unit from gaining access to the programmable memory unit.

2. The programmable memory write protection method of claim 1, wherein the computer platform is a desktop computer.

3. The programmable memory write protection method of claim 1, wherein the computer platform is a network server.

4. The programmable memory write protection method of claim 1, wherein the programmable memory unit is a flash memory unit.

5. A programmable memory write protection system for use with a computer platform equipped with a programmable memory unit for providing the programmable memory unit with a write protection function;
the programmable memory write protection system comprising:
an identification code storage module, which is used to prestore a group of authorized identification code sets;
a write request responding module, which is capable of responding to a write request from a client unit by issuing an identification code requesting enable message;
an identification code requesting module, which is capable of responding to the identification code requesting enable message from the write request responding module by requesting the client unit to furnish a set of identification code; and if the client unit fails to furnish, capable of issuing a write inhibit message;
an identification code comparison module, which is capable of comparing the identification code furnished by the client unit against the identification code stored in the identification code storage module to see if there is a match; if YES, capable of issuing a write enable message; and whereas if NO, capable of issuing a write inhibit message; and
a write operation control module, which is capable of responding to the write enable message from the write operation control module to allow the client unit to perform a write operation on the programmable memory unit, and otherwise capable of responding to the write inhibit message from the write operation control module or the identification code requesting module to inhibit the client unit from gaining access to the programmable memory unit.

6. The programmable memory write protection system of claim 5, wherein the computer platform is a desktop computer.

7. The programmable memory write protection system of claim 5, wherein the computer platform is a network server.

8. The programmable memory write protection system of claim 5, wherein the programmable memory unit is a flash memory unit.

9. The programmable memory write protection system of claim 5, wherein the identification code requesting module displays a identification code input dialog box to request a user-inputted set of identification code.

10. The programmable memory write protection system of claim 5, wherein the identification code requesting module requests the client unit to furnish an embedded set of identification code.
